(19) United States
(12) Patent Application Publication
(10) Pub. No.: US 2013/0293365 A1
(43) Pub. Date: Nov. 7, 2013

(54) Laser-Projected Forklift Pallet Insertion Limit Indicator

(71) Applicant: FORD GLOBAL TECHNOLOGIES, LLC, Dearborn, MI (US)

(72) Inventor: Jason M. Ascencio, White Lake, MI (US)

(73) Assignee: Ford Global Technologies, LLC, Dearborn, MI (US)

(21) Appl. No.: 13/873,377

(22) Filed: Apr. 30, 2013

Related U.S. Application Data
(60) Provisional application No. 61/640,773, filed on May 1, 2012.

(51) Int. Cl. B60Q 1/00

(52) U.S. Cl. CPC B60Q 1/00
USPC 340/425.5

(57) ABSTRACT

A pallet insertion limit indicator includes forklift truck including prongs for engaging, raising and lowering a pallet, a surface secured to the truck and moveable with the prongs, and a laser emitter secured to the surface and able to 5 project onto the prongs a visible indicator.

This application claims priority to and the benefit of U.S. Provisional Application No. 61/640,773, filed May 1, 2012, the full disclosure of which is incorporated herein by reference.

### BACKGROUND OF THE INVENTION

1. Field of the Invention

This invention relates generally to a visible indicator, such as a line projected by a laser emitter, that helps prevent unintentional engagement of a pallet by the prongs of a forklift.

2. Description of the Prior Art

A fork truck can be used to lift and transport a shallow depth pallet or rack, whose depth is less than the length of the fork. In that procedure, sometimes called “short-forking,” the operator can insert the prongs of the fork too far into the shallow pallet causing the fork to penetrate through the other side of the shallow pallet. The outer ends of the fork can extend inadvertently into a second pallet located on the back side of the shallow pallet.

When the operator attempts to lift the shallow pallet, not knowing that the fork has penetrated the second pallet behind the shallow pallet, the second pallet and other pallets stacked on it can topple over and fall onto the fork truck, possibly injuring the operator.

Due to strict safety policies regarding forklift trucks, an indicator that warns about stopping forward motion of the truck when short-forking pallets cannot be attached to the forks or mast by drilling, bolting or welding, although such an indicator can be mechanically connected to the back rest. Neither a painted line nor tape can endure in service for more than a few hours. Brackets cannot be used without prohibited drilling or welding to the fork.

### SUMMARY OF THE INVENTION

A pallet insertion limit indicator includes forklift truck including prongs for engaging, raising and lowering a pallet, a surface secured to the truck and moveable with the prongs, and a laser emitter secured to the surface and able to project onto the prongs a visible indicator.

The laser emitter projects a line, clearly visible to an operator seated in the forklift, onto the floor outside the lateral sides of the fork.

The emitter projects clearly a line across the forks, thereby identifying a fork depth to be used with shallow depth pallets.

The position of the line remains unaltered in the correct position whether the fork is raised, lowered, tilted, opened, closed, or shifted.

The line can be adjusted to project a wide or narrow beam of light. Even with the fork in the up-position, the line can be seen on the inside edge of the fork.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a perspective view of a forklift truck;

FIG. 2 is a side view showing a forklift located in front of columns of stacked, loaded, relatively shallow pallets;

FIG. 3 is a perspective top view of the floor and fork prongs showing a laser emitted line extending laterally across these surfaces;

FIG. 4 is a perspective side view of a laser emitter encapsulated in a stationary mount;

FIG. 5 is a front view of an adjustable laser emitter support bracket;

FIG. 6 is a side view of the bracket of FIG. 5 and showing a laser emitter mounted thereon; and

FIG. 7 is a perspective view of an adjustable laser emitter support bracket.

### DESCRIPTION OF THE PREFERRED EMBODIMENT

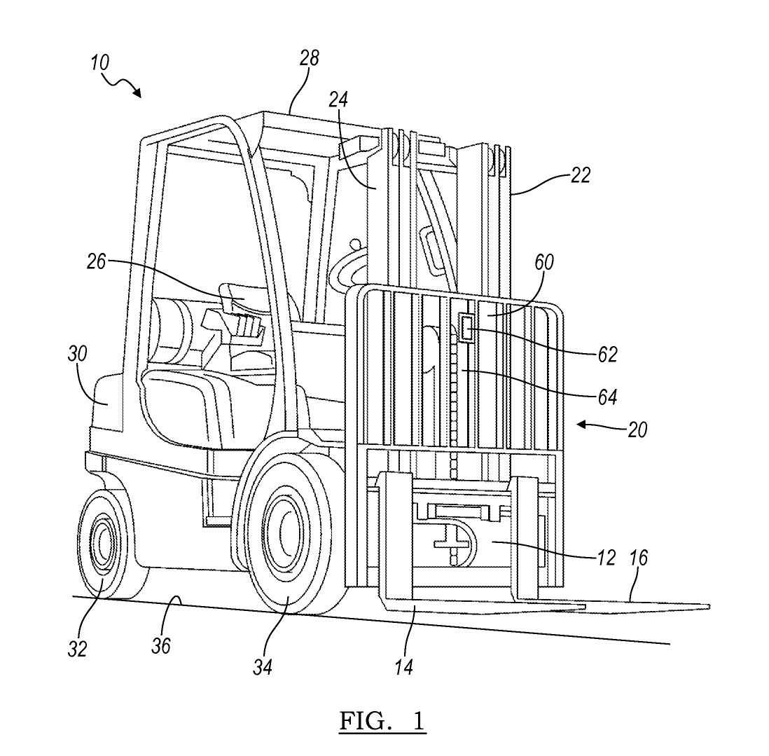

As FIG. 1 shows a forklift truck 10 includes a fork carriage 12; two prongs 14, 16 of a fork assembly 18, which is raised, lowered and tilted by the carriage 12; a backrest 20, secured to the carriage such that the backrest and carriage move as a unit; two masts 22, 24, along the length of which movement of the fork assembly is directed and guided; a seat 26, occupied by the forklift operator; an overhead support frame 28; a body 30; and tired wheels 32, 34 for supporting the truck on the surface 36 of a floor.

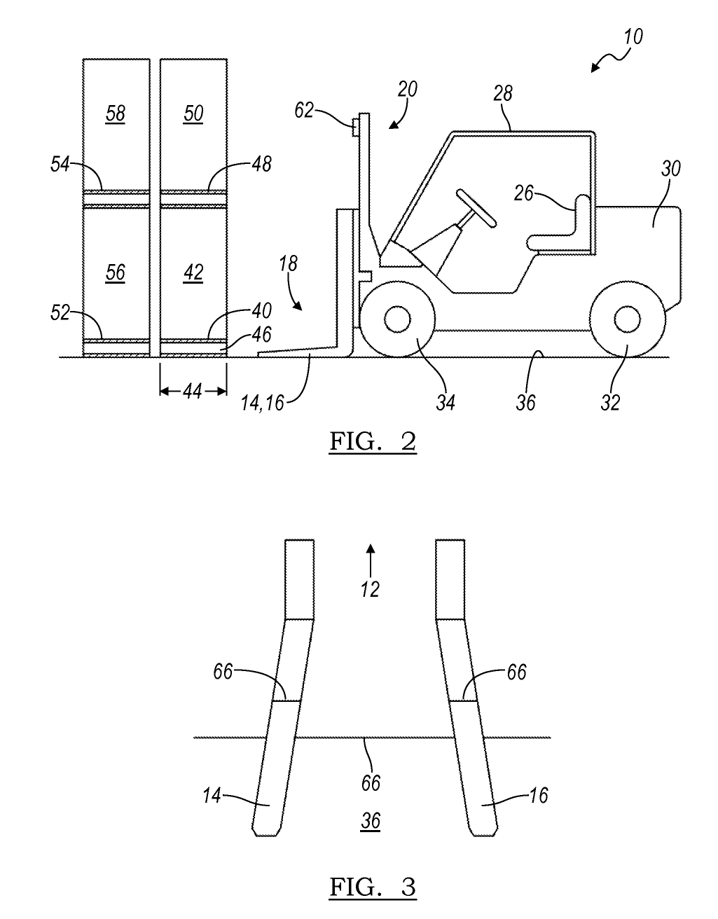

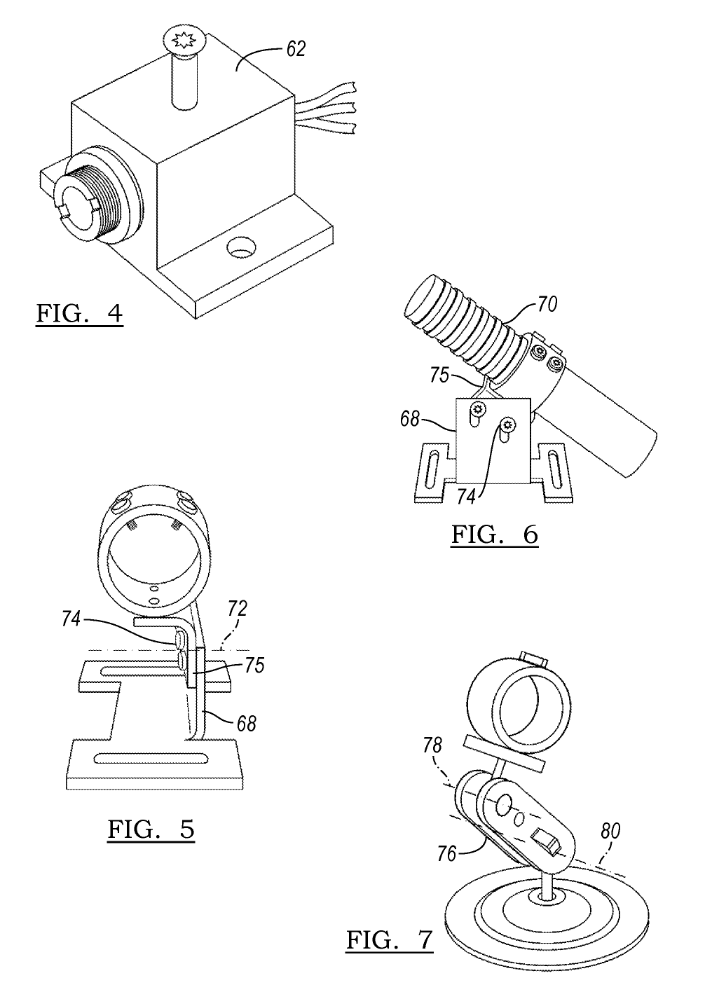

As FIG. 2 illustrates, the fork 18 can engages a pallet 40 on which is located material, equipment, product, goods or merchandise 42. The pallet 40 is engaged by prongs 14, 16 of the fork assembly 18, which moves along the depth 44 of a space 46 between the upper and lower surfaces of the pallet 40. The pallet 40 is lifted on the fork, transported by the truck 10, lowered by the fork into a desired position, and disengaged by the fork.

The pallet 40 that is engaged by the fork 18 may have another pallet 48 or group of ballets stacked on the engaged pallet 40, in which case pallet 48 is also loaded with additional material, equipment, product, goods or merchandise 50.

Because the length of the prongs 14, 16 is greater than the depth 44 of pallet 40, the fork can extend into and engage, at least along a portion of the fork length, also a pallet 52, located behind pallet 40 and such other pallets 54 that are stacked on pallet 52. Then when the fork 18 is lifted to transport pallet 40, pallets 52, 54 and the goods 56, 58 loaded on those pallets are lifted inadvertently without knowledge of the operator.

To avoid this error, a bracket 60 for supporting a laser emitter 62 is secured preferably to one of the vertical rails 64 of the backrest 20, preferably at the center of the backrest 20 between its lateral extremities and aligned with the longitudinal centerline of the truck 10. Bracket 60 may be secured to the backrest 20 mechanically or with a chemical bonding agent, preferably epoxy.

Alternatively bracket 60 and the laser emitter 62 are secured to the fork carriage 12, preferably at a laterally centered location, the beam produced by the emitter being projected onto the surfaces of the prongs 14, 16 and the floor surface 36.

Bracket 60 may support the laser emitter 62 in a stationary position or in an adjustable position, which permits the location of line 64 to vary along the length of the prongs 14, 16 in accordance with the depth 44 of the pallet 40 that is to be transported.

A laser emitter 62 supported on bracket 60 is directed downward and forward onto the upper surface of prongs 14, 16 and onto the floor surface 36. The laser emitter 62 produces a lateral laser line 66 directed laterally, as shown in FIG. 3. Because the upper surfaces of prongs 14, 16 are at a higher elevation than that of the floor surface 36, line 66 is also at a higher elevation on the prongs that it is on the floor surface 36. Line 66 extends laterally onto the floor outboard past the lateral sides of the prongs 14, 16 and between the prongs, so that the operator can see the line clearly while seated in the truck 10.

Preferably the laser emitter 62 projects a bright laser line 66 across the forks prongs 14, 16 several inches deeper than the depth of the shallowest pallet 40. The emitter can be adjusted such that it projects a wide or narrow beam of light. The laser emitters project light in various colors including red and bright green, according the ambient visibility requirements and the operator's vision acuity and limitations.

FIGS. 5 and 6 show an adjustable support bracket 68, which can be used to support a laser emitter 70 and to adjust the angular position of the laser emitter 70 as it pivots about axis 72 and projects line 66 onto the prongs 14, 16 and floor surface 36. Bolts 74, 75 maintain the angular position of emitter 70 in bracket 68.

FIG. 7 shows a support bracket 76, which provides for the position of a laser emitter 70 to be adjusted angularly about two axes 78, 80, such that the emitter projects line 66 onto the prongs 14, 16 and floor surface 36.

The laser emitter 62, 70 may by powered by a battery pack or it may be supplied from the power supply of the forklift truck 10. If the laser emitter 62, 70 is supplied with electric power directly from the battery of a forklift truck 10, a voltage regulator may be required to reduce the voltage from that of the battery, which may be 48 volts or 36 volts, to the voltage of the laser emitter, which may be 5 volts. The laser emitter 62, 70 may be hard-wired to the electrical system of the truck 10 such that it turns on and off automatically when the truck motor is started and stopped. Laser emitters compatible with 12 volt power supply are readily available commercially and would require no voltage reduction when connected to a 12 volt power source.

The visible insertion limit indicator can be used in other applications than a forklift truck to limit the extend to which a projection, of any kind, secured to a transporting device, such as a vehicle, can be inserted into any passageway such as a pipe, fluid or electric conduit, sewer line, etc.

In accordance with the provisions of the patent statutes, the preferred embodiment has been described. However, it should be noted that the alternate embodiments can be practiced otherwise than as specifically illustrated and described.

The invention claimed is:

1. A pallet insertion limit indicator, comprising:
forklift truck including prongs for engaging, raising and lowering a pallet;
a surface secured to the truck and moveable with the prongs;
a laser emitter secured to the surface and able to project onto the prongs a visible indicator.

2. The pallet insertion limit indicator of claim 1, wherein the indicator represents a limit to which the prongs should be inserted into the pallet.

3. The pallet insertion limit indicator of claim 1, wherein said surface is located on one of a backrest or a fork carriage of the forklift truck.

4. The pallet insertion limit indicator of claim 1, wherein the visible indicator is a laterally directed line projected onto the prongs and an area of a floor that extends laterally outboard of the prongs.

5. The pallet insertion limit indicator of claim 1, further comprising a bracket secured to the surface, the laser emitter being secured to the bracket.

6. The pallet insertion limit indicator of claim 5, wherein the bracket includes an axis about which the laser emitter can pivot for changing a location along a length of the prong at which the indicator is projected onto the prongs.

7. The pallet insertion limit indicator of claim 1, wherein the visible indicator is a line extending across the prongs and located at a distance from an outer end of the prongs that is greater than a predetermined depth of the pallet.

8. The pallet insertion limit indicator of claim 1, wherein the forklift truck further includes a power source that provides a voltage source for the laser emitter.

9. A forklift truck, comprising:
prongs for engaging, raising and lowering a pallet;
a surface secured to the truck and moveable with the prongs;
a pallet insertion limit indicator including a laser emitter secured to the surface and able to project onto the prongs a visible indicator represents a limit to which the prongs should be inserted into the pallet.

10. The forklift truck of claim 9, further comprising a backrest and a fork carriage, the surface being located on one of the backrest and the fork carriage.

11. The forklift truck of claim 9, wherein the visible indicator is a laterally directed line projected onto the prongs and an area of a floor that extends laterally outboard of the prongs.

12. The forklift truck of claim 9, further comprising:
a bracket secured to the surface, the laser emitter being secured to the bracket, such that a position of the visible indicator on the prongs can be adjusted.

13. The forklift truck of claim 12, wherein the bracket includes an axis about which the laser emitter can pivot for changing a location along a length of the prong at which the indicator is projected onto the prongs.

14. The forklift truck of claim 9, wherein the visible indicator is a line extending across the prongs and located at a distance from an outer end of the prongs that is greater than a predetermined depth of the pallet.

15. The forklift truck of claim 9, wherein the forklift truck further includes a power source that provides a voltage source for the laser emitter.

16. A visible limit indicator, comprising:
a transporting device including a projection extending along an axis of the transporting device and adapted for insertion into a passageway;
a surface secured to the transporting device and moveable with the projection;
a laser emitter secured to the surface and able to produce on the projection a visible indicator represents a limit to which the projection should be inserted into the passageway.

17. The visible limit indicator of claim 16, further comprising:
a bracket secured to the surface, the laser emitter being secured to the bracket, such that a position of the visible indicator produced on the projection can be adjusted.

18. The visible limit indicator of claim 17, wherein the bracket includes an axis about which the laser emitter can pivot for changing a location along a length of the projection at which the visible indicator is produced onto the projection.

19. The visible limit indicator of claim 16, wherein the visible indicator is a line extending laterally across the projection and located at a distance from an outer end of the projection that is no greater than a predetermined length along the passageway.

20. The visible limit indicator of claim 16, wherein the transporting device further includes a power source that provides a voltage source for the laser emitter.
